(19) United States
(12) Patent Application Publication
(10) Pub. No.: US 2016/0050244 A1
(43) Pub. Date: Feb. 18, 2016

(54) Systems and Methods for Shared Media Streaming

(71) Applicant: Dylan Corlett, New York, NY (US)

(72) Inventor: Dylan Corlett, New York, NY (US)

(21) Appl. No.: 14/828,033

(22) Filed: Aug. 17, 2015

Related U.S. Application Data
(60) Provisional application No. 62/037,863, filed on Aug. 15, 2014.

(51) Int. Cl. H04L 29/06

(52) U.S. Cl. CPC H04L 65/4069

(57) ABSTRACT

Systems and methods for shared media streaming are disclosed. The input stream of media may be received at a server from a client device connected to the server via a network and provided to a display device connected to the network for playback over a media output system. Based upon a set of rules, the server may switch between input streams provided by other client devices connected to the server.

### FIELD OF THE INVENTION

The invention relates generally to systems and methods for shared media streaming.

### BACKGROUND

People assembled in social settings, such as parties, work functions, and the like often share media experiences. A shared media experience typically involves music or video played on a stereo or television during the course of the event. The media may be selected for the group's enjoyment, and attendees can enjoy the media experience actively by listening or watching, dancing, and/or discussing the media. Recently it has become common for attendees at social gatherings to play media by connecting an individual's mobile device directly to a media system (e.g., a television or stereo receiver) located at the event location. In circumstances where access to the media system is open in this manner, several attendees may want to play “their” music at the event. However, doing so requires each attendee to leave his or her mobile device near the media system, and there exists no protocol for gracefully switching between different attendee's selections.

### SUMMARY

Systems and methods are disclosed for shared media streaming that can improve upon the status quo described above by facilitating the order and timing of who will be in charge of the media experience during the course of an event. The system may include a media server that can create an event space and receive input media streams from client devices connected to the event space. The server can select an active streaming device from among client devices connected to the event space and switch to a new active streaming device based on default rules or rules established by an event host.

In some embodiments, a method for providing a shared media experience, involving a server having at least one processor, can be provided. The method can include creating, using the at least one processor, an event space for hosting the shared media experience, and receiving, at the server, requests from a plurality of client devices to join the created event space. The method can also include using the at least one processor to configure a first client device of the plurality of client devices as an active streaming device for streaming media to the server for output and current playback, and configure a second client device of the plurality of client devices as a media playback device for playing back media output from the server. The method can additionally include receiving, at the server, a first input media stream from the first client device, and transmitting a first output media stream based on the received first input media stream, from the server to the second client device for current playback.

In some embodiments, a system for providing shared media experiences can be provided. The system can include a connection manager configured to create event spaces for hosting the shared media experiences, and receive requests from a plurality of client devices to join the created event spaces. The connection manager can also be configured to set each client device in at least a subset of the plurality of client devices as any one of a media playback device for playing back media output by the system, a streaming device for streaming media to the system for potential playback, and an active streaming device for streaming media to the system for current playback. The system can also include an input stream manager configured to receive input media streams from client devices in the at least a subset of client devices set by the connection manager as either a streaming device or an active streaming device, and an output stream manager configured to transmit media streams received at the input stream manager to at least one client device in the at least a subset of client devices set by the connection manager as a media playback device. The system can further include a controller configured to determine what each client device in the at least a subset of client devices should be set as, cause the connection manager to set the client devices in the at least a subset of client devices based on the determination, and cause the output stream manager to transmit the input media streams received at the input stream manager based on the determination.

In some embodiments, a computer program product including a non-transitory medium storing computer executable program logic for providing a shared media experience, involving a server, can also be provided. The computer executable program logic can be configured to cause at least one data processor of the server to create an event space for hosting the shared media experience, receive requests from a plurality of client devices to join the created event space, and configure a first client device of the plurality of client devices as an active streaming device for streaming media to the server for output and current playback. The computer executable program logic can also be configured to configure a second client device of the plurality of client devices as a media playback device for playing back media output from the server, receive a first input media stream from the first client device, and transmit a first output media stream based on the received first input media stream, from the server to the second client device for current playback.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 shows a schematic diagram of a system for shared media streaming, in accordance with some embodiments;

FIG. 2 shows a detailed schematic diagram of a server connected to client devices and a display device via a network, in accordance with some embodiments;

FIG. 3A-3C show exemplary screenshots of an application for shared media streaming running on a client device, in accordance with some embodiments; and

FIG. 4 shows a flowchart of an exemplary process 200 for shared media streaming, in accordance with some embodiments.

### DETAILED DESCRIPTION

The various embodiments disclosed herein may facilitate a shared media streaming experience. Generally speaking, the disclosed systems and methods permit several users to take turns sharing media for an audience. Members of the audience may submit real-time feedback on the media experience such as by voting on what is currently playing, for example. The system can use this feedback to lengthen or shorten the time that the person currently “in charge” of the media experience may remain in charge. Advantageously, media can be streamed via a network (typically wireless) that will eliminate the need to directly connect an attendee's device to the media system at an event.

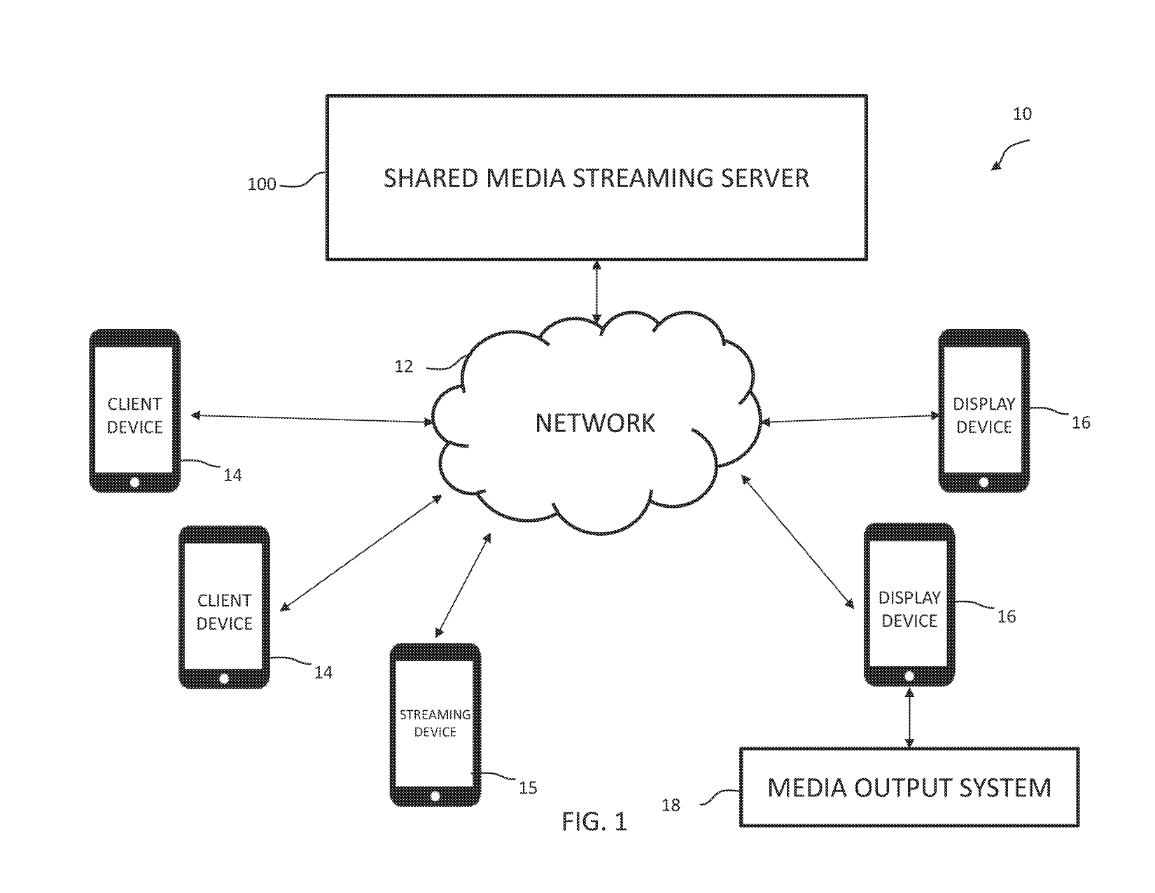

FIG. 1 shows a schematic diagram of system 10 for shared media streaming, in accordance with some embodiments. System 10 may include a shared media streaming server, server 100, connected to any number of client devices 14 via network 12. Server 100 may also be connected to display devices 16, which may be capable of receiving media, such as audio or video, for example, and providing that media to media output system 18, which can play the media for an audience.

Generally speaking, and as disclosed in more detail below, server 100 can receive separate media streams from client devices 14, determine which media stream should be played, and send the determined media stream to display devices 16 for output by display devices 16 directly or using media output system 18. In some embodiments, display devices 16 can be media playback devices configured to playback media, such as videos, audio content, and/or image data. To accomplish these and other tasks, server 100 may include one or more processors, memories, I/O devices, and communications modules to execute software or firmware for implementing one or more aspects of the embodiments disclosed herein. As described in detail below, once connected to server 100, each one of client devices 14 may be configured as an active streaming device and/or a display device. Thus, as used herein the term “client device” may refer generically to any electronic device connected to server 100 or more specifically to an electronic device connected to server 100 that is not configured as a streaming device or a display device.

Client devices 14 may include any electronic devices capable of connecting to server 100 over network 12, such as an audio player, a video player, a music recorder, a game player, a video recorder, a camera, a radio, a cellular telephone or other wireless communication device, a personal digital assistant, a programmable remote control, a pager, a laptop computer, a desktop computer, a tablet device, or combinations thereof. In some cases, a client device may be an electronic device that can perform multiple functions (e.g. play music, display video, store pictures, and receive and transmit telephone calls), such as a smartphone, for example.

Client devices 14 can each include, among other components, one or more processor(s), memories, and communications modules. These components may all be part of client device 14 or individual components may be physically separate from and connected to client device 14. The processor(s) may be connected to the other components of client device 14 (e.g., via a communications bus) to control and operate the device.

In some embodiments, the processor may execute instructions stored in memory, which may include one or more different types of memory, such as one or more of several caches, flash memory, RAM, ROM, and/or hybrid types of memory. The processor(s) may include, for example, one or more microcontrollers and/or microprocessors that can execute instructions from one or more software or firmware applications stored in the memory. The processor(s) may also control one or more input/output (“I/O”) modules of client device 14. Examples of I/O modules may include, for example, a digital display, an audio-output device, such as an audio-out jack or a speaker, a touch-screen interface, and/or one or more peripheral devices, such as a keyboard or mouse.

Further, client devices 14 may each include a communications module having circuitry that enables client device 14 to be communicatively coupled to another device, such as server 100, display devices 16, and/or other client devices 14. The communications module may allow client device 14 to connect to network 12 using any suitable communications protocol. For example, the communications module may create a short-range communications network using a short-range communications protocol to connect to other devices or systems located close to client device 14. For example, the communications module may be operative to create or connect to a local communications network using the Bluetooth™ protocol to couple with a Bluetooth™ headset. The communications module may also include a wired or wireless network interface card (“NIC”) configured to connect to the Internet or any other public or private network, such as network 12, for example. Client device 14 may be configured to connect to the Internet via a wireless network, such as a packet radio network, an RF network, a cellular network, or any other suitable type of network.

In some embodiments, network 12 may be an ad-hoc network. Ad-hoc networks can facilitate communications between electronic devices using existing infrastructure, such as Wi-Fi networks, for example, or using peer-to-peer communications protocols, such as Wi-Fi connections and near-field communications protocols, such as Bluetooth™, for example. Once established, an ad-hoc network may permit compatible electronic devices to discover, join, and communicate with one another over the network.

Client devices configured as streaming devices 15 may provide media to server 100 for playback via display devices 16. One or more of streaming devices 15 that are currently providing one or more media streams to display devices 16 may be termed an “active streaming device” hereinafter. The media may be any type of known media, such as audio (e.g., music, audio books, podcasts, or talk radio), video (e.g., movies, video clips, music videos), or still images, for example. Media sent from client devices 14 to server 100 may be stored locally on the client device, streamed from a third-party media service, or a combination of the two. As described in detail below, server 100 may receive the media from one or more streaming devices 15, choose which media to play, and send that media to display devices 16 for output via the display devices and/or media output system 18.

Display devices 16 may be client devices capable of connecting to server 100 via network 12, receiving a media stream, and playing the media stream for an audience. In some embodiments, one or more of display devices 16 may connect to media output system 18 in order to play the media stream via one or more components of the media output system. Display devices 16 may, therefore, be understood as client devices 14 that have been configured to receive and play a media stream received from server 100. Accordingly, display devices 16 may include an electronic device owned and/or controlled by a person hosting an event at which media output system 18 is configured to produce a shared media experience or an electronic device owned by any other attendee who wishes to (and is permitted to, based on rules established on server 100) receive a media stream from server 100 directly. This arrangement obviates the need for other event attendees (e.g., the owners of client devices 14) to communicatively couple their electronic devices to media output system 18 in order to create a shared media experience.

Media output system 18 may be any suitable electronic device for transmitting media to an audience. Accordingly, media output system 18 may include one or more media components, such as one or more displays (e.g., a tube or flat-screen television), audio output devices (e.g., speakers), and/or an A/V receiver that can, among other things, receive a media signal, amplify an audio signal received from one of display devices 16, and/or route audio and video signals to one or more other components of media output system 18. In some embodiments, one or more components of display devices 16 may be housed in media output system 18, which may obviate the need for a separate electronic device to intermediate between media output system 18 and server 100.

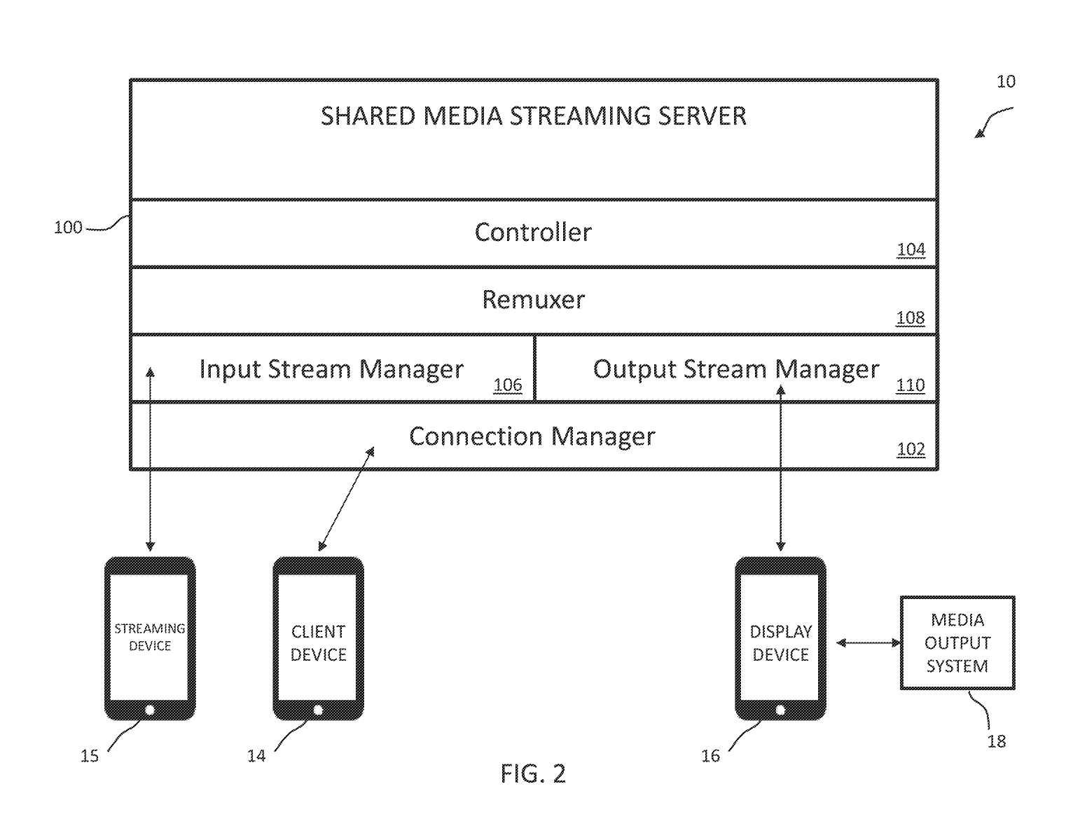

FIG. 2 shows a detailed schematic diagram of server 100 connected to client devices 14 and display devices 16 via a network, in accordance with some embodiments. As depicted in FIG. 2, server 100 may include connection manager 102, controller 104, input stream manager 106, media multiplexer 108, and output stream manager 110. These modules of server 100 may work with one another to receive media from client devices 14, choose media to play, and deliver the chosen media to display devices 16. It should be understood that while modules 102-110 are depicted as being part of server 100, which may be physically embodied as a hardware component that may be communicated with via network 12, the functionalities of one or more of the modules may be performed by another system component, such as client devices 14, streaming devices 15, display devices 16, or media output system 18. In circumstances where network 12 is an ad-hoc network, the functionalities of server 100 may be distributed among client devices 14, streaming devices 15, display devices 16, and/or media output system 18.

To begin a shared media experience in accordance with various embodiments, connection manager 102 may receive instructions from a user, such as a user of one of the client devices, for example, to create an “event space.” An event space may be understood as a virtual network that includes one or more of client devices 14, streaming devices 15, display devices 16, and server 100 provided for the purpose of generating a shared media experience. In one example, connection manager 102 (and/or one or more other modules of server 100) can include logic code that instructs (e.g., via command(s)) one or more processors of server 100 to create a virtual network (e.g., using a communications module of server 100, such as a network interface card). The event space may be accessible via an “event address,” which may be a uniform resource locator (“URL”) link that is shared with potential attendees, for example. In some embodiments, software running on client devices 14 may provide access to the event address to a particular event space.

Access to an event space may be controlled using a number of parameters. For instance, for a user to receive the event address to a particular event space, a user may be required to be in a certain geographical area as determined by GPS coordinates of the user's client device, proximity to a Wi-Fi network, or connection to a local ad-hoc network, for example. As another example, an event space creator may provide the event address to particular users (e.g., by contacting the users directly using an application or via an email or messaging service), or the user may be required to be part of a social networking group. It should be understood that users connected to an event space may be located in geographically diverse locations or in relatively close proximity to one another.

According to various embodiments, an event space may continue to exist indefinitely, until a certain event occurs, or it may be time-bound. For example, an event space may continue to exist while at least one client device is still connected to the event space, for a predetermined period of time (e.g., four hours), or until the event creator or an event host manually terminates the event space.

Connection manager 102 may also configure the client devices connected to the event space as streaming devices and/or display devices. How connection manager 102 handles the configuration may depend on rules defined for the purpose. For example, connection manager 102 may configure a client device to be a streaming and/or display device based on individual requests from each client device, requests from an event host, requests from controller 104, default rules defined on server 100, or combinations of the above.

Server 100 can include controller 104, which may be responsible for choosing which of streaming devices 15 are “active streaming devices.” Active streaming devices may be defined herein as the streaming devices from which media is ultimately being played via one or more of display devices 16. That is, while a number of streaming devices 15 may be connected to server 100 and attempting to play media over display devices 16, only those streaming devices 15 that are currently providing a media stream being output to display devices 16 may be considered active streaming devices. It should be understood that for a given event space, there may be one or more streaming devices, one or more active streaming devices, and one or more display devices and, at any given moment, controller 104 may determine which streaming devices should be configured as active streaming devices and which display devices should receive media streams from the active streaming devices.

The active streaming devices may be chosen on the basis of one or more rules set up by the “event host.” The event host may be the same user as the event creator or a different user connected to the event space. In most cases, the event host may be the owner and/or controller of one of display devices 16 and/or media output system 18. However, it should be understood that any user connected to the event space may act as the event host as permitted by rules established by the event creator or by default rules if the event creator did not establish any rules at the time the event space was created. It should be appreciated that an event host can set or change any rules in an event via an administrative or user interface provided by server 100. For example, server 100 can include logic code (e.g., that may be included in logic code for one or more of the various modules of server 100, such as controller 104, or that may be separate standalone logic code) that causes a display (of server 100 or coupled to server 100) to graphically display an interface. The interface can, for example, include user selectable options or input fields for setting one or more event parameters discussed below.

The event host may be permitted to alter the rules governing which user or users may act as the event host, how the event space is to be terminated, and/or how controller 104 chooses the active streaming device. These rules may be established, for example, based on communications between one of client devices 14, streaming devices 15, display devices 16, or another network connected device and server 100. In some embodiments, an application running on one of the aforementioned devices may facilitate access to and alteration of the rules. Rules for a given event space may be stored in a database accessible to server 100, client devices 14, streaming devices 15, and/or display devices 16. In some embodiments, the database may be a component of server 100.

In some embodiments, the rules may restrict the users who are permitted to act as the event host. For example, the rules may designate the event creator or one or more particular users to be the event host. To illustrate this point, the owner of media output system 18 may set up an event space using display device 16, communicatively the couple display device 16 to media output system 18, and either act as the event host using a client device or designate another user with a client device connected to the event space as the event host.

As noted above, the rules may also define how controller 104 chooses the active streaming device from among client devices 14 connected to server 100. The rules may dictate, for example, that a particular client device may remain the active streaming device for a predetermined amount of time or until a predetermined number of discrete media items (e.g., five songs) are played.

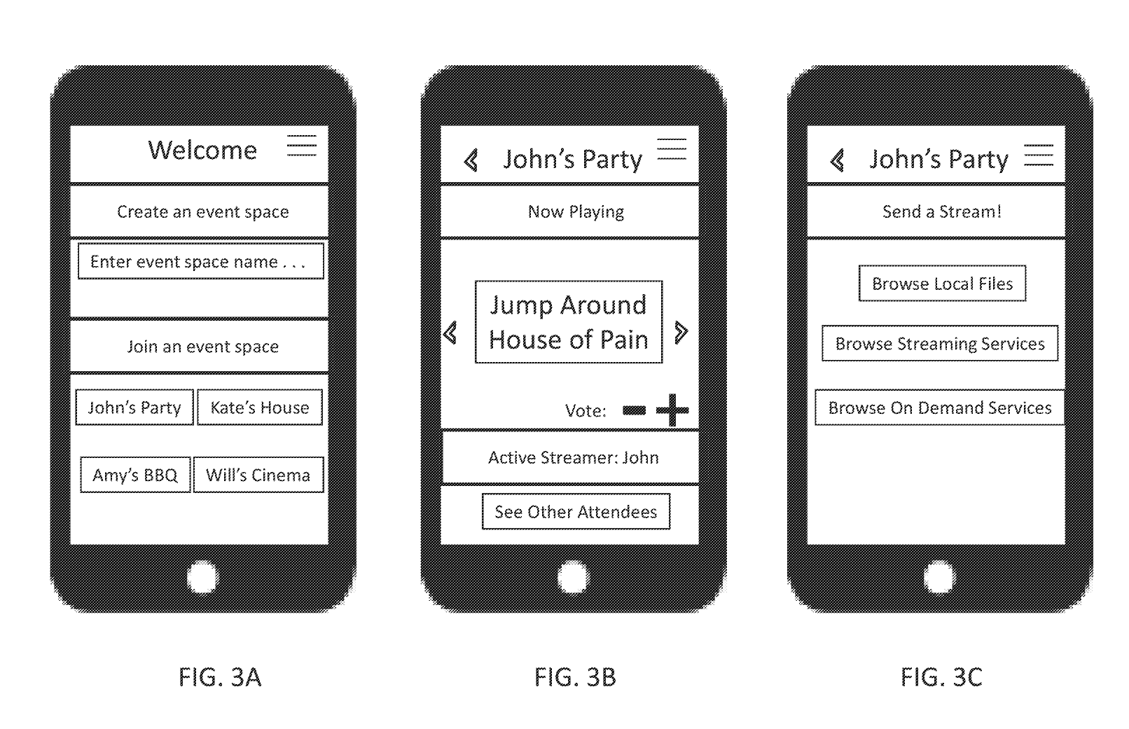

The time during which an active streaming device remains active can be defined as a session. If a different device (e.g., another client device 14 or another streaming device 15) is set as an active streaming device, then the session can be reset and a new session can be started for the newly set active streaming device. As noted above, controller 104 can set a different device as an active streaming device based on one or more rules. As another example, a user of the current active streaming device can manually give up being the active streaming device and pass control back to a queue that may be managed by controller 104. This could arise if the user had to leave the event or was no longer interested in continuing. An option for signaling controller 104 of that user's desire to end his or her “turn” can be presented and selectable via an app (described in more detail below with respect to FIGS. 3A-3C), for example, that may be resident on that user's device.

In some embodiments, controller 104 may receive feedback from users of other client devices that may be used to determine how long the active streaming device may remain in control of the media played by media output system 18. The feedback may be received in turns of “votes,” which can indicate that a particular user likes or dislikes the media currently being played. In these embodiments, the rules may define various vote thresholds for determining when to switch from the current active streaming device to a new active streaming device. One or more of the defined thresholds may be applied coextensively, such that controller 104 may switch to a new active streaming device upon detecting that any of the conditions set in the rules have been met.

In one example, a threshold may be defined with respect to the currently playing media. That is, if the votes against the currently playing media reach a certain threshold value (e.g., 50% or 60% of the vote total), controller 104 can switch to a new active streaming device.

In another example, one or more thresholds may be defined with respect to the last ‘N’ media items played by the active streaming device. That is, controller 104 may choose a new active streaming device based on votes placed on all or a recent history of all the media played by the active streaming device. In one particular example, controller 104 may choose a new active streaming device upon determining that all of the last five media items played by the active streaming device received negative votes reaching a certain threshold value (e.g., 20% or 30%).

In still another example, users may be permitted to view a list of future media items to be played by the active streaming device. The users may then be permitted to vote on whether or not they approve of the list to determine whether controller 104 should choose a new active streaming device. Users may also be permitted to view and vote on lists of media items proposed to be played by other users via media output system 18. In these embodiments, the client device of the user who provides the most popular proposed list of media items may be chosen as the new active streaming device.

In various embodiments, controller 104 can implement one or more algorithms and/or define and utilize one or more parameters for setting different devices as new active streaming devices. The parameters can include any of the following: the number of “up” votes (“UV”) for the current session, the number of “down” votes (“DV”) for the current session, the maximum play time (“MAX”) that any given device is allowed to play (e.g., which may be set during configuration of an event space, either by default or by an event host), the minimum play time (“MIN”) that any given device is allowed to play (e.g., which may be set during configuration of an event space, either by default or by an event host), the average or midpoint of MIN & MAX above [i.e., (MIN+MAX)/2], the total number of votes (“TV”), the percentage of positive votes (“Positive Ratio”, “PR”, or “U %”) (e.g., by calculating UV/TV), allowed play time (“APT”) (e.g., which may be session-specific, and which may be a calculated value that represents how long the current active streaming device will be allowed to play before switching to another device), and current play time (“CPT”) (e.g., which may be session-specific, and which may be a timer that tracks how long the current active streaming device has been set as an active streaming device). It should be appreciated that, in some embodiments, the percentage of positive votes (e.g., U %) can alternatively be calculated as UV/DV.

In some embodiments, the value of APT can be set by controller 104 to a reasonable default at the beginning of a session, and can be continually adjusted throughout the session based on the values of UV, DV, and TV (e.g., from votes received from participants during the session) as well as other suitable parameters. In at least one embodiment, controller 104 can set another device as the active streaming device when the value of APT equals or exceeds the value of CPT for a current active streaming device. It should be appreciated that the switchover to a new active streaming device may or may not be instantaneous. For example, in some embodiments, controller 104 can set a different device as the new active streaming device by first alerting that device so that the user of that device can prepare and queue up media for playback (if that user has not already previously done so). In particular, controller 104 can include logic code that causes one or more processors of server 100 to send one or more instructions to the device to be set as the new active streaming device. The instructions received at that device can, for example, cause the device to react, such as vibrating, outputting one or more sounds, or the like. The output(s) can signal or alert the user of that device that the device has been selected as the next active streaming device. In some embodiments, controller 104 can, within a predetermined time (e.g., 20 seconds) after alerting the selected device, additionally cause playback of media submitted by the still-current active streaming device to fade out as part of ending the current session. Controller 104 can also cause one or more display devices 16 and/or media output system 18 to announce to event participants that the selected device is the next (or is now) the active streaming device. The announcement can be made by sending instructions to display devices 16 or media output system 18 to present (e.g., audibly or visually) identifying information regarding the selected device (e.g., information identifying the user of that device, such as the user's name, or the like). Regardless of whether any such announcement is made, controller 104 can set a new session that ends the prior session, and cause media from the newly-selected active streaming device to be played back. It should be appreciated that the new session can begin by causing playback of media submitted by the newly-selected active streaming device to fade in. It should also be appreciated that the media streams from the prior active streaming device and the newly-selected active device can additionally, or alternatively, be “mixed” (e.g., via beat-matching and/or mixing of the streams) so as to provide a seemingly seamless transition or media experience.

As described above, controller 104 can set a different device as the new active streaming device based on votes received from participants in an event. In at least one embodiment, controller 104 can implement an algorithm that reduces the impact of up and down votes (e.g., the values of UV and DV) received during an early part of a session [e.g., during the first few seconds, during the first few minutes of a session, when only a small number of votes (e.g., two or three votes) has been received, or the like]. This can avoid one vote from dramatically affecting a positive vote/negative vote ratio and cause controller 104 to set a different device as the active streaming device. For example, the very first vote received during a session can be either a UV or DV. If this single vote is taken into consideration by controller 104, it would undesirably result in a 100% positive or a 100% negative feedback ratio.

In at least one embodiment, controller 104 can implement an algorithm for setting and adjusting the APT. The algorithm can include the following logic:
When: TV<2:
   APT set to: midpoint [i.e., (MAX−MIN)/2]
When: 2<=TV<10
   Recalculate MAX and MIN
      NewMax=MAX−[(MAX−midpoint)*0.5]
      NewMin=MIN+[(MAX−midpoint)*0.5]
   APT set to: [U %*(NewMAX−NewMIN)]+NewMIN (this can soften the ratio while votes continue to build)
When: 10<=TV
   APT set to: [U %*(MAX−MIN)]+MIN
      After 10 or more votes are received, the algorithm can use the raw positive vote percentage (e.g., UV/TV) to determine how close the APT should be to the MAX or MIN values. It should be appreciated that the values ‘2’, ‘10’, and ‘0.5’ are only exemplary, and other values can instead be used in the algorithm.

The following describes an example of the various calculations made using the above-mentioned algorithm during a particular session. At the beginning of the session, the event host can set the value of MIN to 30 minutes and the value of MAX to 60 minutes. At this point, CPT is 0 minutes, APT is 45 minutes, UV is 0, and DV is 0.

In this example, one of the connected devices can be selected as an active streaming device, allowing the user of that device to start streaming his or her media. Nominally, the user has 45 minutes (i.e., APT) to playback his or her media, but this value can be adjusted up or down depending on the DVs and UVs received during the session. Nevertheless, the user will be able to playback his or her media for at least 30 minutes (i.e., MIN), but not more than 60 minutes (i.e., MAX). At any point during the session, the user can also give up control, as described above.

Continuing the example, if after 10 minutes of playback, the user has received 3 UVs and 1 DV, then the following settings or calculations can be made:

CPT=10 minutes

U %=3/4=0.75

NewMAX=60−((60−45)*0.5)=52.5

NewMIN=15+((60−45)*0.5)=22.5

APT=(0.75*(52.5−22.5)+22.5=45 minutes

Since CPT<APT, the system takes no action and the active streaming device is allowed to continue streaming media.

Continuing the example, if after another 20 minutes of playback, the user has received a total of 6 UVs and 1 DV, then the following settings or calculations can be made:

CPT=30 minutes

U %=6/7=0.857

NewMAX=60−((60−45)*0.5)=52.5

NewMIN=15+((60−45)*0.5)=22.5

APT=(0.857*(52.5−22.5)+22.5=48.21

Since CPT<APT, the system takes no action and the active streaming device is allowed to continue streaming media.

Continuing the example, if after another 10 minutes of playback, the user has received a total of 6 UVs and 20 DVs, then the following settings or calculations can be made:

CPT=40 minutes

U %=6/26=0.231

APT=(0.231*(60−30)+30=36.93

At this point, since CPT>APT, a switch is triggered and the next active streaming device can be chosen.

In at least one embodiment, controller 104 can additionally or alternatively implement another algorithm for setting and adjusting the APT. This algorithm can be simpler, whereby calculations are performed only during a later part of a session when sufficient votes have been received. The algorithm can include the following logic:
When: TV<=4:
   APT set to: midpoint [i.e., (MAX−MIN)/2]
When: 5<=TV
   APT set to: [U %*(MAX−MIN)]+MIN

In various embodiments, server 100 can also prepare post-event metrics. In particular, controller 104 can be configured to monitor and store the various parameters (or other pertinent information) during one or more sessions of an event, and can generate a report based on this data. For example, controller 104 can include logic code that causes one or more processors of server 100 to store (e.g., in memory on server 100) the parameter values (e.g., for APT, MIN, MAX, etc.) during each session of an event. Controller 104 can additionally include logic code that causes the processor(s) to store in memory other information regarding the session, such as identifying information regarding each device that was set as the active streaming device, times when certain system actions take place (e.g., when votes are received), etc. Controller 104 can then generate a report by compiling, sorting, manipulating (via addition, subtraction, multiplication, division, and/or other mathematical operations) the information into meaningful metric categories. For example, controller 104 can include logic code that causes the processor(s) to retrieve the stored parameters and/or session information and derive metrics. The metrics can include data regarding the device or user of the device who received the most “up” votes (e.g., highest UV value), the device or user of the device who had the longest APT (e.g., most playing time). or the like. In some embodiments, the logic code can cause the processor(s) to create a timeline (e.g., using the session information) that shows the vote trends during one session or throughout an entire event. The logic code can additionally, or alternatively, cause the processor(s) to create a timeline of the devices or users of those devices who “played” their media during the event, the actual media items (e.g., songs) that were played, the votes each device or user received during the event, the types of votes (e.g., positive, negative, or neutral) they received, or the like.

In some embodiments, a number of devices may be connected to server 100 as mere streaming devices (e.g., volunteers), but only one device may be set as the active streaming device. Some or all of the streaming devices may be queued in server 100 as potential selectees as the active streaming device. For example, one or more of connection manager 102 and controller 104 can include logic code that causes the processor(s) of server 100 to queue the devices (e.g., by storing a list of information for the currently connected devices) for potential selection as an active streaming device.

Various options can be set for determining which streaming device in a queue is to be set as an active streaming device. In some embodiments, controller 104 can include logic code that causes the processor(s) to randomly select a device as the next active streaming device. In some embodiments, the logic code can include instructions that cause the processor(s) to randomly pick a device from the queue whose media has previously been played the least number of times. For example, if four users' devices have each played for one session, three users' devices have each played for two sessions, and one user's device has played for three sessions, then the logic code can cause the processor(s) to randomly select a device from the four users' devices (that have each only played for one session) as the next active streaming device. In some embodiments, the logic code can include instructions that cause the processor(s) to randomly pick a device from the queue that has previously received a large number of votes and/or a large number of positive votes. This can, for example, be a randomized algorithm with a preference for volunteers with high vote count or high positive vote percentage in a current event and/or in prior events. As described above, all information regarding an event can be stored in memory accessible to server 100. That is, the total number of votes for each device can be stored for the current event as well as for all prior events in which that device was a participant. The logic code can cause the processor(s) to retrieve vote data regarding all devices in a current event and/or in prior events to determine vote counts and/or vote types for those devices, and randomly select the next active streaming device based on this determination.

In some embodiments, the event host may retain the ability to override the rules at any time to manually switch from the active streaming device to a new active streaming device. For example, if the event host wishes to allow each event participant to playback their media for the same amount of time, the event host can set the MIN and MAX values to the same value (e.g., 30 minutes).

Input stream manager 106 may receive media from client devices 14 communicatively coupled to server 100 in the form of input streams. An input stream may be a data stream originating at a client device that includes one or more media items, and thus may be an input media stream. The input stream can also include identifying information regarding the user, the user's client device, the location of the client device, the media included in the input stream, etc.

In some embodiments, each client device connected to the event space can send a continuously-running stream of media to input stream manager 106. The stream of media may be based on media stored locally on the user's client device (e.g., a playlist) or may originate from a stream from a third-party content source (e.g., streaming media content source or an on-demand content source). In these embodiments, controller 104 may switch from one input stream to another when it chooses a new active streaming device.

Input stream manager 106 may cache the individual input streams for a suitable amount of time to prevent switching to a new input stream in the midst of a media item. That is, the new input stream may begin playing from the beginning of the current media item in the input stream rather than the current location. The cache may alternatively hold the entirety of each input stream received at input stream manager 106. In this manner, when controller 104 switches to a new active streaming device, it can begin playing the cached media stream from the beginning. This approach can allow for the input stream from a particular client device to play a faithful reproduction of what the user intended and help to avoid gaps in playback due to connectivity issues.

In other embodiments, a client device connected to the event space may only send an input stream to input stream manager 106 when chosen by controller 104 as the active streaming device. As part of choosing a new active streaming device, controller 104 can handshake with the new active streaming device and begin receiving its input stream. This handshake process may occur in advance of the switch to the new active streaming device to avoid gaps in playback.

Server 100 may include media multiplexer 108 to combine and/or process the input streams from the selected active streaming devices. Media multiplexer 108 can receive one or more input streams from input stream manager 106 and process those streams as directed by controller 104, such as by combining streams, separating streams, compressing streams, add/or removing elements or data from each stream. The output of media multiplexer 108 may then be sent to output stream manager 110 for transmission to display devices 16.

Media multiplexer 108 may select a single input stream corresponding to the active streaming device from a number of potential input streams. The selected input stream may then be passed to output stream manager 110, which can then send the selected input stream to display devices 16 as an output stream, which may then be played via display devices 16 and/or over media output system 18. In some embodiments, the output stream may be sent to multiple display devices, which may be configured to play the output stream directly or to provide the output stream to a media output system, such as media output system 18.

Media multiplexer 108 may also combine multiple input streams from a number of potential input streams. In this manner, client devices 14 may alternate between being the active streaming device on a schedule set by controller 104 and implemented by media multiplexer 108. The multiple input streams may be combined such that the various input streams play in a predetermined order or randomly.

Media multiplexer 108 may further route separate input streams to different display devices. In these embodiments, controller 104 may instruct multiplexer to route one input stream to a first set of display devices, another input stream to a second set of display devices, and so on. The instructions to separately route input streams may be based on feedback from the display devices. To illustrate these embodiments, consider a set of users whose choice of media items may be known to be especially well received by an audience (“trendsetters”). Trendsetters may provide input streams to server 100, which can determine how to route the input streams to sets of other users (“followers”). In some embodiments, each follower may request the input stream provided by a particular trendsetter, or controller 104 may determine that a particular input stream would be enjoyed by a set of followers. Media multiplexer 108 can, therefore, separate each input stream and route the streams appropriately.

Media multiplexer 108 may still further remove media items from an input stream under some circumstances. For example, if controller 104 detects that two identical, or very similar, media items are set to play in close succession, such as within a certain number of media items being played or within a certain period of time, for example, media multiplexer 108 may be instructed to remove the duplicate media item from one or more of the output streams provided to output stream manager 110. Controller 104 may detect identical or similar media items on the basis of metadata received from the active streaming devices that indicates which media items are in the input streams and when those media items are queued to play in each input stream. In another example, media multiplexer 108 may remove media items that are not formatted to play on media output system 18, such that if media output system 18 does not include a display, the output stream provided thereto can be stripped of video media.

Further still, media multiplexer 108 may process and combine multiple input streams, such as by removing the highs or lows from a particular audio input stream using an equalizer, fading in and out between the streams, or creating a “mash up” of the multiple input streams, for example. In this manner, two or more active streaming devices may coordinate in an event space (e.g., with one active streaming device sending audio input stream #1 with the highs removed (bass only), and the other sending audio stream #2 with the lows removed (treble only)). These multiple input streams could be combined into a single audio stream and sent to display devices 16.

The one or more output streams from media multiplexer 108 may be received at output stream manager 110, which can then send each output stream to the appropriate display device. As noted above, output stream manager 110 may receive a single output stream addressed to a single display device or multiple display devices, or output stream manager 110 may receive multiple output streams addressed to multiple display devices. To handle the routing, each output stream may be associated with a device address corresponding to an address of the device that was established when the device joined the event space.

FIG. 3A-3C show exemplary screenshots of an application for shared media streaming running on a client device, in accordance with some embodiments. The client device can include a system, such as an app (e.g., an application or program having one or more modules), configured to interact with server 100. For example, as shown in FIG. 3A, the app can provide a user interface that allows a user to submit instructions to server 100 (e.g., to connection manager 102 of server 100) to create event spaces or join existing ones. The app can also receive information regarding current media being played in an event space, and provide one or more user selectable options (for example, vote buttons shown in FIG. 3B) for submitting feedback on that media (which server 100 can, for example, use to determine whether John's device should remain the active streaming device). If server 100 has set the client device as a streaming device or an active streaming device, the app can also present a user interface that allows the user to select media (e.g., either stored on the client device itself or from one or more third party streaming services) for transmission to server 100 for potential playback.

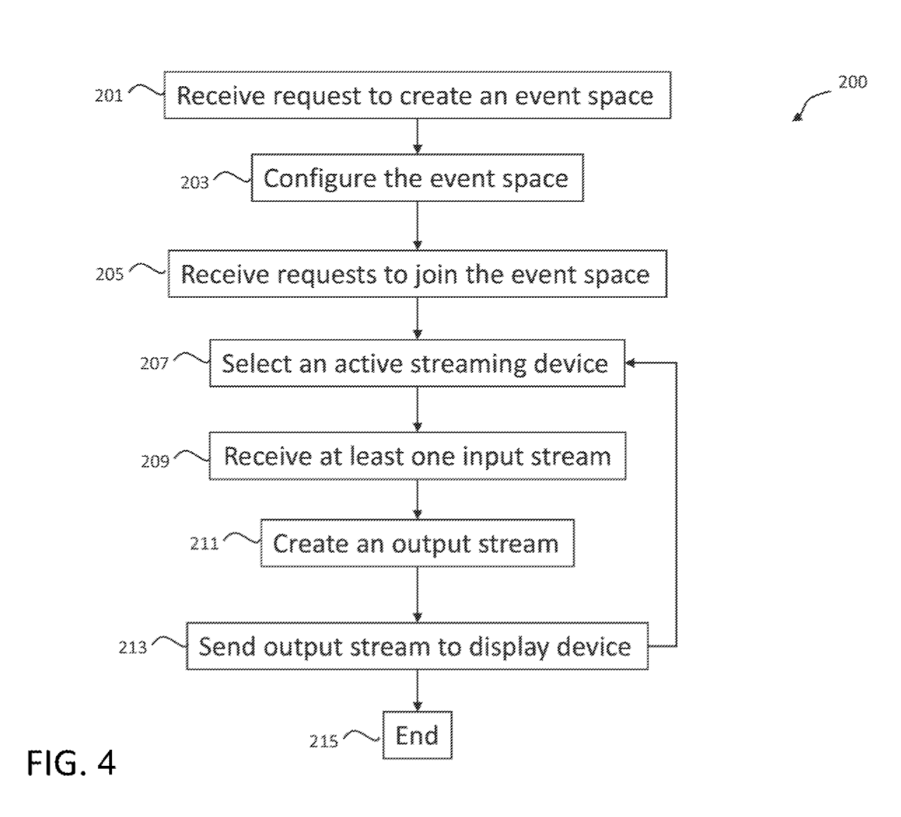

FIG. 4 shows a flowchart of an exemplary process 200 for shared media streaming, in accordance with some embodiments. Process 200 may begin at step 201, in which a server (e.g., shared streaming media server 100 of FIG. 1) can receive a request to create an event space. The request may be received from an electronic device (e.g., one of client devices 14, streaming devices 15 or display devices 16 of FIG. 1) connected to the server via a network (e.g., network 12 FIG. 1), which may be an established network, such as the Internet, an ad-hoc network, or a combination of one or more established and ad-hoc networks. The request to create the event space may include identifying information about the event space, such as an event name, for example.

At step 203, the server can configure the event space. The event space may be configured based on information in the request, based on default rules used by the server, and/or based on input from a client device connected to the event space. In some embodiments, only the user who is designated as the event host (who may be the user who requested the event space or another user or users chosen by the event creator) may send the server instructions to configure the event space. Configuring the event space may involve determining which users may join the event space and how the server will choose an active streaming device from among users who join the event space, for example. According to various embodiments, the event space may be password protected, open to users who receive an invitation from the event host, open to users in close physical proximity to the event host, open to social media contacts of the event host, or open to all users regardless of their physical location or connection to the event host, for example.

At step 205, a connection manager of the server (e.g., connection manager 102 of FIG. 2) can receive requests to join the event space. For example, client devices 14 can issue electronic requests [e.g., via hypertext transfer protocol (“HTTP”) or other similar communication protocol] over network 12 to server 100. Connection manager 102 can include logic code that instructs (e.g., via command(s)) one or more processors of server 100 to receive, parse, and/or analyze these requests to identify the originating client devices and process the requests. Users may be permitted to join the event space if they meet the criteria set during the event space configuration at step 203. Upon receiving the requests, the connection manager can configure each electronic device connected to the event space as a client device, a streaming device, and/or a display device. In some embodiments, connection manager 102 can communicate or otherwise interface with a complementary software application resident on the client devices requesting to join the event space, and can transmit one or more instructions to each of those devices as to the particular mode that they should be operated in, such as a client device mode, a streaming device mode, an active streaming device mode, and/or a display device mode. In various embodiments, connection manager 102 can additionally, or alternatively, include logic code that instructs one or more processors of server 100 to store identification information for the client devices (e.g., via a data structure in memory on server 100) and associate that information with the appropriate mode. For example, for one client device, connection manager 102 can instruct the processor(s) to store identifying information for that device and associate it with data indicative that the device is to be treated as a streaming device. As another example, for another client device, connection manager 102 can instruct the processor(s) to store identifying information for that device and associate it with data indicative that the device is to be treated as a display device. Generally speaking, client devices configured as streaming devices may be permitted to stream media to the event space and client devices configured as display devices can receive streaming media from the event space. However, it should be understood that a particular electronic device connected to the event space may be configured as both a streaming device and a display device or neither a streaming device nor a display device. The server may assign each device connected to the event space a unique device identifier that may be used to differentiate between the electronic devices connected to the event space. In various embodiments, controller 104 can determine how each connected client device should be configured (e.g., based on rules and/or various other conditions discussed above), and can issue one or more instructions to connection manager 102 on how to configure the devices accordingly.

At step 207, the server (e.g., controller 104 of FIG. 1) can select an active streaming device. The active streaming device may be selected from among the client devices connected to the event space according to the rules established at step 203. For instance, the rules may allow the event host to manually designate a particular user's device as the first active streaming device, the event host's client device may be designated as the first active streaming device, the first active streaming device may be chosen at random, or the first active streaming device may be selected based on feedback (e.g., votes) received from client devices connected to the event space. In other examples, the first active streaming device may be selected based on a user's popularity in the system (e.g., as determined on a feedback record from prior streaming experiences) or the first active streaming device may be chosen on the basis of the user's name (e.g., by alphabetical order).

At step 209, the server can receive at least one input stream from the active streaming device and other client devices connected to the event space. According to various embodiments, an input stream may be received from each device that has provided media to play through the event space or an input stream may only be received from the active streaming device. The input streams may be received at an input stream manager (e.g., input stream manager 106 of FIG. 2), which can route the input streams to a multiplexer (e.g., media multiplexer 108 of FIG. 2). As one example, input stream manager 106 can include logic code that instructs one or more processors of server 100 to communicatively couple (e.g., via networking hardware on server 100) to one or more of the connected client devices so that input streams can be received from those devices. In some embodiments, input stream manager 106 can issue instructions to the processor(s) to store received input streams (e.g., in memory on server 100, on a disk drive, such as a hard-drive, on flash storage, or the like).

At step 211, the multiplexer can create an output stream based on the input stream(s) received from the input stream manager. To create the output stream, the multiplexer may combine, separate, compress, and/or remove and/or modify elements or data from the input streams. In various embodiments, the multiplexer can include logic code that instructs one or more processors of server 100 to manipulate received input streams by adding, removing, and/or revising data elements, such as pixels and/or signal frequencies. The processor(s) can utilize any suitable video processing algorithms, audio processing algorithms, and/or image processing algorithms to process the input streams. According to various embodiments, the multiplexer may receive a single input stream and create a single output stream, receive a single input stream and create multiple output streams, receive multiple input streams and create a single output stream, or receive multiple input streams and create multiple output streams. The output stream(s) may then be routed to an output stream manager (e.g., output stream manager 110 of FIG. 2), which can send the output stream(s) to the appropriate display device(s) at step 213. In various embodiments, controller 104 can include logic code that instructs the processor(s) to determine whether and how the output stream(s) should be output (e.g., based on which client devices are currently configured as display device(s), which client devices are currently configured as streaming devices, and/or which client devices are currently configured as active streaming devices). Controller 104 can also include logic code that instructs the processor(s) to control output stream manager 106 such that one or more of the output stream(s) are transmitted to the appropriate devices (e.g., to client devices that are configured as display devices). It should be appreciated that the respective logic code for connection manager 102, controller 104, input stream manager 106, multiplexer 108, and output stream manager 110 can be separate individual software applications or programs, or alternatively, be included as part of a single software application or program. In some embodiments, one or more of modules 102-110 can be resident on a single standalone server, a dedicated server, a virtual server, a cloud server, or a client device (e.g., one of client devices 14, a smartphone, or the like).

Process 200 may continue to send the output stream(s) to the display device(s) until the server returns to step 207 to select a new active streaming device. The server may select a new active streaming device based on the rules established at step 203, which may provide that a new active streaming device be chosen based on feedback (e.g., votes) from client devices connected to the event space or upon a predetermined event (e.g., that a predetermined amount of time has passed or a predetermined number of media items have been played) occurring.

Process 200 may continue in this manner until reaching the end at step 215. Process 200 may reach step 215 under any one of a number of circumstances, such as the event host manually ending the event, a predetermined number of users leaving the event, a predetermined amount of time passing, or a predetermined number of media items having been played, for example.

Each functional component described above may be implemented as stand-alone software components or as a single functional module. In some embodiments the components may set aside portions of a computer's random access memory to provide control logic that affects the interception, scanning and presentation steps described above. In such an embodiment, the program or programs may be written in any one of a number of high-level languages, such as FORTRAN, PASCAL, C, C++, C#, Java, Tel, PERL, BASIC, Ruby, or Objective C. Further, the program can be written in a script, macro, or functionality embedded in commercially available software, such as EXCEL or VISUAL BASIC.

Additionally, the software may be implemented in an assembly language directed to a microprocessor resident on a computer. For example, the software can be implemented in Intel 80×86 assembly language if it is configured to run on an IBM PC or PC clone. The software may be embedded on an article of manufacture including, but not limited to, computer-readable program means such as a floppy disk, a hard disk, an optical disk, a magnetic tape, a PROM, an EPROM, or CD-ROM.

The invention can be embodied in other specific forms without departing from the spirit or essential characteristics thereof. The foregoing embodiments are therefore to be considered in all respects illustrative rather than limiting on the invention described herein.

What is claimed is:

1. A method for providing a shared media experience, involving a server having at least one processor, the method comprising:
creating, using the at least one processor, an event space for hosting the shared media experience;
receiving, at the server, requests from a plurality of client devices to join the created event space;
using the at least one processor:
configuring a first client device of the plurality of client devices as an active streaming device for streaming media to the server for output and current playback; and
configuring a second client device of the plurality of client devices as a media playback device for playing back media output from the server;
receiving, at the server, a first input media stream from the first client device; and
transmitting a first output media stream based on the received first input media stream, from the server to the second client device for current playback.

2. The method of claim 1, wherein the event space comprises a virtual network accessible via a uniform resource locator (“URL”).

3. The method of claim 1, further comprising:
receiving, at the server, a request from one client device of the plurality of client devices to create the event space, wherein creating the event space is effected based on at least one of:
the received request; and
at least one predefined rule.

4. The method of claim 1, wherein configuring the first and second client devices is effected based on at least one of:
at least one predefined rule;
individual requests from the first and second client devices;
a request from one client device of the plurality of client devices set as a host of the shared media experience;
random selection;
feedback submitted by at least one client device of the plurality of client devices;
popularity of users of the first and second client devices; and
names of the users of the first and second client devices.

5. The method of claim 1, further comprising:
configuring, using the at least one processor, a third client device of the plurality of client devices as a streaming device such that the third client device is prohibited from streaming media to the server.

6. The method of claim 1, further comprising:
configuring, using the at least one processor, a third client device of the plurality of client devices as a streaming device such that the third client device is permitted to stream media to the server for potential playback by the second client device;
receiving, at the server, a second input media stream from the third client device; and
caching, using the at least one processor, the received second input media stream for potential output to the second client device.

7. The method of claim 6, further comprising:
reconfiguring, using the at least one processor:
the first client device as a streaming device; and
the third client device as an active streaming device;
halting, using the at least one processor, output of the first output media stream from the server to the second client device; and
transmitting a second output media stream based on the cached second input media stream, from the server device to the second client device for current playback.

8. The method of claim 7, wherein reconfiguring the first and third client devices is effected based on at least one of:
a predetermined time having elapsed after the first client device was configured as an active streaming device;
a predetermined number of media items in the first output media stream having been played back by the second client device;
feedback from at least one of the plurality of client devices regarding at least one of the received first and second input media streams; and
a request from one client device of the plurality of client devices set as a host of the shared media experience.

9. The method of claim 8, wherein processing the received first input media stream comprises at least one of:
compressing at least a portion of the received first input media stream;
adding at least one of data and elements to the received first input media stream; and
removing at least one of data and elements from the received first input media stream.

10. A system for providing shared media experiences, comprising:
a connection manager configured to:
create event spaces for hosting the shared media experiences;
receive requests from a plurality of client devices to join the created event spaces; and
set each client device in at least a subset of the plurality of client devices as any one of:
a media playback device for playing back media output by the system;
a streaming device for streaming media to the system for potential playback; and
an active streaming device for streaming media to the system for current playback;
an input stream manager configured to receive input media streams from client devices in the at least a subset of client devices set by the connection manager as either a streaming device or an active streaming device;
an output stream manager configured to transmit media streams received at the input stream manager to at least one client device in the at least a subset of client devices set by the connection manager as a media playback device; and
a controller configured to:
determine what each client device in the at least a subset of client devices should be set as;
cause the connection manager to set the client devices in the at least a subset of client devices based on the determination; and
cause the output stream manager to transmit the input media streams received at the input stream manager based on the determination.

11. The system of claim 10, wherein the connection manager is configured to create the event spaces as virtual networks accessible via uniform resource locators (“URLs”).

12. The system of claim 10, wherein the controller is configured to determine what each client device in the at least a subset of client devices should be set as based on at least one of:
at least one predefined rule accessible to the controller;
individual requests from the client devices in the at least a subset of client devices;
a request from one client device of the plurality of client devices configured as an event host;
random selection;
feedback submitted by at least one client device of the plurality of client devices;
popularity of users of the client devices in the at least a subset of client devices; and
names of the users of client devices in the at least a subset of client devices.

13. The system of claim 10, wherein each of the input media streams received at the input stream manager comprises at least one of:
at least one media item stored locally on the corresponding client device; and
a stream provided by a third-party content source.

14. The system of claim 10, wherein each of the input media streams received at the input stream manager comprises at least one of:
video data;
audio data;
still image data; and
text data.

15. The system of claim 10, further comprising:
a media multiplexer configured to process the input media streams received at the input stream manager.

16. The system of claim 15, wherein the media multiplexer is configured to process the input media streams by at least one of:
combining the input media streams;
compressing at least a portion of at least one of the input media streams;
separating portions of at least one of the input media streams;
adding at least one of data and elements to at least one of the input media streams;
removing at least one of data and elements from at least one of the input media streams;
removing at least one of similar and duplicate media items in the input media streams;
removing at least one media item in at least one of the input media streams that none of the client devices in the at least a subset of clients devices set by the connection manager as a media playback device is capable of playing back;
for at least one common media item in the input media streams, removing (i) highs from the at least one common media item in one of the input media streams and (ii) lows from the at least one common media item in at least another of the input media streams; and
adjusting at least one media item in at least one of the input media streams to at least one of fade in and fade out during playback.

17. The system of claim 15, wherein the controller is further configured to:
cause the media multiplexer to process the input media streams received at the input stream manager based on the determination.

18. A computer program product comprising a non-transitory medium storing computer executable program logic for providing a shared media experience, involving a server, the computer executable program logic configured to cause at least one data processor of the server to:
create an event space for hosting the shared media experience;
receive requests from a plurality of client devices to join the created event space;
configure a first client device of the plurality of client devices as an active streaming device for streaming media to the server for output and current playback;
configure a second client device of the plurality of client devices as a media playback device for playing back media output from the server;
receive a first input media stream from the first client device; and
transmit a first output media stream based on the received first input media stream, from the server to the second client device for current playback.

19. The computer program product of claim 18, wherein the computer executable program logic is configured to cause the at least one data processor to configure the first and second client devices based on at least one of:
at least one predefined rule;
individual requests from the first and second client devices;
a request from one client device of the plurality of client devices set as a host of the shared media experience;
random selection;
feedback submitted by at least one client device of the plurality of client devices;
popularity of users of the first and second client devices; and
names of the users of the first and second client devices.

20. The computer program product of claim 18, wherein the computer executable program logic is further configured to cause the at least one data processor to:
configure a third client device of the plurality of client devices as a streaming device such that the third client device is permitted to stream media to the server for potential playback by the second client device;
receive a second input media stream from the third client device; and
cache the received second input media stream for potential output to the second client device.
